(19) United States
(12) Patent Application Publication
(10) Pub. No.: US 2025/0217265 A1
(43) Pub. Date: Jul. 3, 2025

(54) USING COMPLEXITY METRICS TO ASSESS CODE GENERATED USING ARTIFICIAL INTELLIGENCE

(71) Applicant: INTERNATIONAL BUSINESS MACHINES CORPORATION, ARMONK, NY (US)

(72) Inventors: ANDREW C. M. HICKS, HIGHLAND, NY (US); MICHAEL GAGLIARDI, SOMERSET, MA (US); RYAN LO, POUGHKEEPSIE, NY (US)

(21) Appl. No.: 18/398,300

(22) Filed: Dec. 28, 2023

(51) Int. Cl. G06F 11/36

(52) U.S. Cl. CPC G06F 11/3608

(57) ABSTRACT

Using complexity metrics to assess code generated using artificial intelligence includes generating, by an artificial intelligence (AI) language model, output source code based on input source code; identifying respective complexity scores for the input source code and the output source code using one or more complexity metrics; and generating, based on an evaluation of the respective complexity scores, a validation score for the output source code.

### BACKGROUND

The present disclosure relates to methods, apparatus, and products for using complexity metrics to assess code generated using artificial intelligence. Migrating the functionality of legacy source code to a more modern programming language can increase the maintainability and readability of the source code as well as improve system performance. However, such a migration is an arduous task that can include writing, testing, validating, and debugging massive amounts of code.

### SUMMARY

According to embodiments of the present disclosure, various methods, apparatuses and products for using complexity metrics to assess code generated using artificial intelligence are described herein. In some aspects, an artificial intelligence (AI) language model is used to remap application source code from an original codebase to a target codebase while maintaining the same functionality. In some aspects, complexity metrics are used to validate the translation of the original application source code to the AI-generated source code. Using an assumption that the complexity of the input source code and the output source code should be similar to some degree, the respective complexity metric scores of the input source code and the output source code indicate the translation accuracy of the AI-generated code. In some aspects, when the complexity metric scores diverge, the AI language model is prompted to regenerate the code. In this way, the complexity score comparison facilitates code validation when migrating from an original codebase to a new codebase, such as from a first programming language to a second programming language or from a legacy system to a modernized system, using AI-generated code.

In a particular embodiment, a method of using complexity metrics to assess code generated using artificial intelligence includes generating, by an artificial intelligence (AI) language model, output source code based on input source code. The method also includes identifying respective complexity scores for the input source code and the output source code using one or more complexity metrics. The method also includes generating, based on an evaluation of the respective complexity scores, a validation score for the output source code. In this way, a comparison of the complexity of the input source code and the output source code can be used to assess the accuracy of the automated code generation to determine whether the control flow and structure of the original source code has been maintained. For example, the input source code can be implemented in a first programming language and the output source code can be implemented in a second programming language that is different from the first programming language. The one or more complexity metrics can include one or more of a cyclomatic complexity metric, one or more Halstead metrics, a live variable metric, a knot metric, and a complexity index based on a plurality of complexity metrics.

In some variations, identifying respective scores for the input source code and the output source code using one or more complexity metrics includes calculating a first complexity score for the input source code using a plurality of complexity metrics such that the first complexity score represents a combination of the plurality of complexity metrics. This variation also includes calculating a second complexity score for the output source code using the plurality of complexity metrics such that the second complexity score represents a combination of the plurality of complexity metrics. In this way, multiple complexity metrics can be represented by a single score for comparison.

In some variations, generating, based on an evaluation of the respective complexity scores, a validation score for the output source code includes adjusting a weight of a complexity score of at least one of the input source code and the output source code based on its programming language. In this way, inherent differences in the complexity of different programming languages are compensated.

In some variations, the method also includes regenerating, by the AI language model based on the validation score, the output source code from the input source code. In this way, the AI language module can iteratively regenerate the output source code until an acceptable validation score is achieved.

In some variations, the method also includes indicating that the validation score is outside of an acceptable tolerance. In this way, a software engineer can be alerted when the automated code generation has failed to accurately reproduce the input source code.

In some variations, the method also includes generating, subsequent to retraining the AI language model, a second validation score for regenerated output source code. This variation further includes quantifying an improvement of the AI language model based on at least the validation score and the second validation score. In this way, the accuracy and reliability of the AI language model can be assessed and the result of retraining the AI language model can be measured.

In some aspects, an apparatus may include a processing device; and memory operatively coupled to the processing device, wherein the memory stores computer program instructions that, when executed, configure the processing device to perform the above-described operations. In some aspects, a computer program product comprising a computer readable storage medium may store computer program instructions that, when executed, configure a computer to perform above-described operations.

### BRIEF DESCRIPTION OF THE DRAWINGS

FIG. 1 sets forth a block diagram of an example computing environment for using complexity metrics to assess code generated using artificial intelligence in accordance with some embodiments of the present disclosure.

FIG. 2 sets forth a flowchart of an example method for using complexity metrics to assess code generated using artificial intelligence in accordance with some embodiments of the present disclosure.

FIG. 3 sets forth a flowchart of another example method for using complexity metrics to assess code generated using artificial intelligence in accordance with some embodiments of the present disclosure.

FIG. 4 sets forth a flowchart of another example method for using complexity metrics to assess code generated using artificial intelligence in accordance with some embodiments of the present disclosure.

FIG. 5 sets forth a flowchart of another example method for using complexity metrics to assess code generated using artificial intelligence in accordance with some embodiments of the present disclosure.

FIG. 6 sets forth a flowchart of another example method for using complexity metrics to assess code generated using artificial intelligence in accordance with some embodiments of the present disclosure.

### DETAILED DESCRIPTION

In the world of software development, the need for modernizing a codebase from one programming language to another has become increasingly prevalent. For example, the source code for an application may be migrated from a legacy programming language (e.g., COBOL) to a modern programming language (e.g., Java). The motivation for such a migration may be to facilitate easier maintenance and readability of the source code, increase security and error handling, improve software and/or hardware performance, and other advantages that will be recognized by those of skill in the art.

In accordance with the present disclosure, artificial intelligence (AI) is used to port or migrate source code of an application to a different programming language. A large language model (LLM) is trained on datasets that include massive amounts source code to develop generative AI that can output source code based on an input or prompt. That is, the AI language model is used to generate new source code based on an input of original source code. For example, an AI language model may be given a prompt such as “Generate Java code that achieves the same objectives as the following COBOL code,” where the legacy COBOL source code is provided as an input. In response, the AI language model may output, at least ideally, AI-generated Java source code that performs the same functions and produces the same output as the legacy.

However, migrating a codebase to a new language introduces a significant challenge in ensuring the accuracy and functionality of the translated code, especially when leveraging AI for automated translations. The difficulty lies in the validation of AI-generated code translations and ascertaining whether the translated code preserves the intended logic, functionality, and structure of the original code. The inherent complexity of programming languages, coupled with the ways in which developers express their logic, poses a challenge in reliably validating the correctness and similarity of AI-generated translations. Further, validating output source code translated from input source code requires an analysis of hundreds of thousands if not millions of lines of code.

The present disclosure addresses the challenges associated with validating the accuracy of AI-generated code translations, with a specific focus on enhancing the reliability and maintainability of automated code translation through the comparison of complexity scores. For example, cyclomatic complexity, a quantitative measure of the complexity of a program, serves as a valuable metric for assessing the intricacy of control flow structures. By comparing complexity scores of input source code and output source code, where the complexity scores are expected to be substantially similar, it is ensured that the translated code not only replicates the logical flow of the original but also maintains a similar level of structural intricacy. A threshold can be set (e.g., the scores must be within a difference of 5) to validate that they are indeed similar, and if the threshold is not met, the AI language model can regenerate the code until the threshold is met.

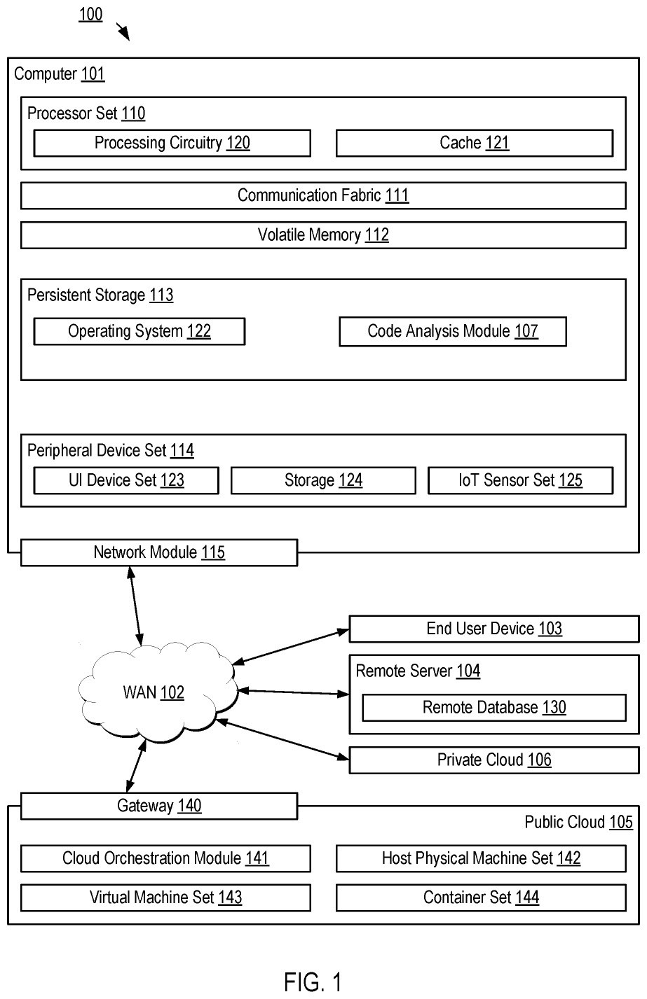

With reference now to FIG. 1, shown is an example computing environment according to aspects of the present disclosure. Computing environment 100 contains an example of an environment for the execution of at least some of the computer code involved in performing the various methods described herein, such as the code analysis module 107. In addition to the code analysis module 107, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and code analysis module 107, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document. These computer readable program instructions are stored in various types of computer readable storage media, such as cache 121 and the other storage media discussed below. The program instructions, and associated data, are accessed by processor set 110 to control and direct performance of the computer-implemented methods. In computing environment 100, at least some of the instructions for performing the computer-implemented methods may be stored in code analysis module 107 in persistent storage 113.

Communication fabric 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in code analysis module 107 typically includes at least some of the computer code involved in performing the computer-implemented methods described herein.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database), this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the computer-implemented methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

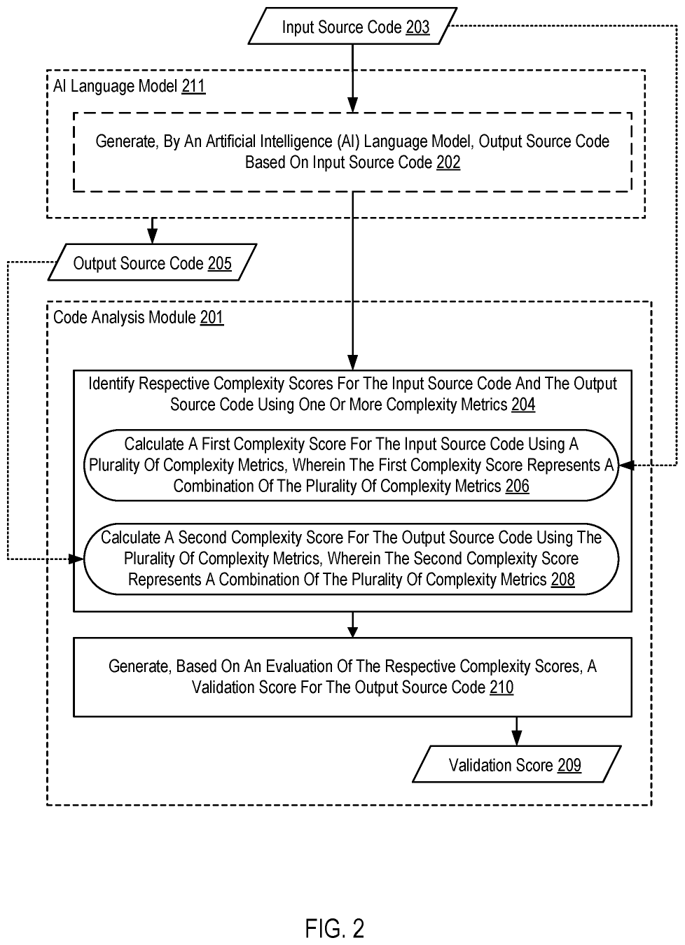

For further explanation, FIG. 2 sets forth a flowchart of an example method of using complexity metrics to assess code generated using artificial intelligence in accordance with some embodiments of the present disclosure. The method of FIG. 2 may be performed, for example, by a code analysis module 201 such as the code analysis module 107 of FIG. 1. In some examples, the code analysis module 201 may be implemented as a process or service that includes an AI language model that generates output source code form input source code. In other examples, the code analysis module 201 may be implemented as part of a process or service separate from a process or service that includes an AI language model. In further examples, the code analysis module 201 may be implemented as part of a process or service monitors the quality of the AI language model to assess whether retraining of the AI language model is appropriate or successful.

The method of FIG. 2 includes generating 202, by an artificial intelligence (AI) language model 211, output source code 205 based on input source code 203. The AI language model 211 may be trained on massive datasets of original source code in a first programming language that has been remapped to source code in a different programming language. As such, the AI language model 211 is configured to autonomously translate a block of input source code in one programming language to a block of output source code in a different programming language. In some examples, the output source code 205 is generated by prompting the AI language model to generate output source code based on the input source code 203. For example, the AI language model may be prompted “Generate Java source code from block A of COBOL source code” where block A is provided as the input source code. In response, the AI language model generates Java source code that is intended to provide the same interfaces, perform the same functions, and generate the same outputs as the original COBOL source code. In some examples, the input source code and the output source code reflect a migration of source code of an application from a first programming language (e.g., a legacy codebase) to a second programming language (e.g., a modern codebase). For example, the input source code may include legacy source code written in an older programming language (e.g., COBOL), whereas the output source code may be implemented in a modern programming language (e.g., Java); however, both the input source code and the output source code are intended to achieve the same objectives, provide the same interfaces, and produce the same output.

The method of FIG. 2 includes identifying 204 respective complexity scores for the input source code 203 and the output source code 205 using one or more complexity metrics. In some implementations, the code analysis module 201 identifies 204 the respective complexity scores by computing the respective complexity scores for the input source code 203 and the output source code 205, as will be described in more detail below. In other implementations, rather than computing the complexity scores for the input source code and the output source code, the code analysis module 201 identifies 204 the respective complexity scores by receiving complexity scores for the input source code 203 and the output source code 205 that are calculated by a separate complexity analysis utility.

In some examples, the code analysis module 201 uses, as a complexity metric, cyclomatic complexity to identify the respective complexity scores of the input source code and output source code. Cyclomatic complexity is a software metric used to measure the complexity of a program's control flow. It was developed by Thomas J. McCabe and thus is sometimes referred to as the McCabe number or McCabe complexity. The cyclomatic complexity of a program is calculated based on the number of linearly independent paths through its source code. This metric is particularly useful in assessing the maintainability and testability of a software system.

Cyclomatic complexity can be determined by constructing a control flow graph of a module of code (e.g., a function or method) where each statement is a node and where an edge connects a first node to a second node if control can pass from a first statement to a second statement. In some examples, the formula for cyclomatic complexity can be defined as: V=E−N+2P, where V is the cyclomatic complexity, E is the number of edges in the control flow graph of the program, N is the number of nodes in the control flow graph, and P is the number of connected components (for a single, linear program P=1). For a single function or method, the cyclomatic complexity can be defined as: V=E−N+2.

In simpler terms, cyclomatic complexity can be understood as the number of decision points or branches in a program. Thus, in some examples cyclomatic complexity can be defined as: V=D, where V is the cyclomatic complexity and D is the number of decision points in the code (e.g., the number of conditional statements or branch points). It is an indicator of the program's structural complexity and is often associated with the number of test cases needed to achieve thorough test coverage.

A higher cyclomatic complexity suggests a more complex program structure, which may lead to increased difficulty in understanding, testing, and maintaining the code. As a rule of thumb, a lower cyclomatic complexity is desirable, as it tends to indicate simpler and more manageable code. For collections of modules (e.g., methods, classes, subroutines), the complexities of the individual functions they contain can be used to determine the total, average or maximum cyclomatic complexity. The cyclomatic complexity per line of source code can be expressed as a decision density.

In some examples, the code analysis module 201 uses, as a complexity metric, one or more Halstead metrics to identify the respective complexity scores of the input source code and output source code. Halstead complexity metrics, developed by Maurice H. Halstead, are a set of metrics designed to quantify various aspects of software programs, with a focus on the volume and difficulty of code. These metrics were intended to provide a quantitative assessment of software complexity and aid in predicting software development efforts.

To calculate the Halstead metrics, n1 is defined as the number of distinct operators, n2 is defined as the number of distinct operands, N1 is defined as the total number of operators, and N2 is defined as the total number of operands. The program vocabulary n is then expressed as n=n1+n2. The program length N is expressed as N=N1+N2. The calculated program length N′ can be expressed as N′=n1 log₂ n1+n2 log₂ n2. The program volume V is a metric expressing the volume or size of the program and can be calculated as V=N log₂ n.

As any program must have at least two operators: one for function call and one for end of the statement, the ratio (n1)/2 can be considered the relative level of difficulty due to the larger number of operators in the program. The ratio (N2)/n2 represents the average number of times an operand is used. This ratio may be large in a program where variables are changed more frequently. As such programs are harder to understand, the difficulty D of reading or writing the program can be calculated as D=(n1*n2)/(2*n2).

The effort E is a metric estimating the amount of time needed by a human to write the code as can be calculated as E=D×V, where D is the difficulty metric and V is the program volume discussed above. The time T to write the code can be calculated as T=E/18 seconds. The number of delivered bugs B can be estimated as B=V/3000.

The Halstead metrics provide insights into program size, the diversity of operators and operands, and the difficulty of understanding the code. A high program volume may indicate a large and potentially complex program, while high program difficulty suggests that the code may be challenging to comprehend.

In some examples, the code analysis module 201 uses, as a complexity metric, raw metrics to identify the respective complexity scores of the input source code and output source code. Certain raw metrics can be used as indicators of complexity, including the number of lines of code (LOC) in the program, logical lines of code (LLOC), source lines of code (SLOC), percentage of comment lines, and percentage of blank lines.

In some examples, the code analysis module 201 uses, as a complexity metric, a live variable metric to identify the respective complexity scores of the input source code and output source code. The live variable metric is a measure of program complexity based on the number of live variables associated with statements in a program. It provides a quantitative assessment of the cognitive load and difficulty associated with understanding and maintaining the code. Live variables, in the context of this metric, refer to variables whose values remain relevant or needed at certain points in the program's execution. The more live variables a program has, the more challenging it can be to comprehend and maintain. Therefore, the live variable metric serves as an indicator of the program's complexity.

Specifically, live variables are those whose values are still in use or needed at specific points in the program. A variable is considered “live” from its first reference to its last reference within a module, encompassing all statements between these references. A particular statement is considered to be associated with a live variable if that statement falls between the first occurrence and last occurrence of the variable within program. Static code analysis can be used to calculate the live variable metric by counting, for each statement, the number of live variables associated with that statement. The metric provides insight into the complexity of each statement based on the number of live variables it involves.

The metric can be extended to the entire module by calculating the average number of live variables. The average live variable metric is determined by summing up the counts of live variables for all executable statements in the module and then dividing this sum by the total number of executable statements. A higher average live variable metric indicates a more complex module, as it suggests that there are, on average, more variables whose values need to be tracked and understood throughout the program's execution. The metric provides a quantitative measure of the cognitive load placed on a programmer trying to understand or maintain the code.

In some examples, the code analysis module 201 uses, as a complexity metric, a knot metric to identify the respective complexity scores of the input source code and output source code. The knot metric expresses the complexity and unstructured-ness of a module's control flow. The knot metric can be calculated by counting the number of intersections among the control flow paths through a module of code. To illustrate, an arrow can be drawn from the point of control transfer to its destination. The more intertwined these arrows become, the more complex the program.

In some examples, the code analysis module 201 uses, as a complexity metric, a naturalness metric to identify the respective complexity scores of the input source code and output source code. The naturalness of a particular statement in the source code is represented by the number of occurrences of that statement within the corpus of training data that was provided to the AI language model. A portion of code having statements with low occurrences in the training data may indicate that the portion of code is complex. The naturalness metric can be expressed by the percentage of statements in the block of code whose occurrence value is below a particular threshold.

In some examples, the code analysis module 201 uses, as a complexity metric, ultrametric topology metric to identify the respective complexity scores of the input source code and output source code. Ultrametric topology relates to an analysis of hierarchical functional relationships and can be used to model landscape complexity. Land units on a map are connected to functions indicating direction of movement or exchange of information between a pair of land units. Land units and functions are part of an encompassing landscape unit. Here, ultrametric topology is adapted to code by defining modules of code (e.g., functions, methods, classes, subroutines) as ‘land units’ or nodes that are connected to one another through ultrametric functions indicating an exchange of information of passage of control flow. Connections between nodes are edges, such that the ultrametric distance between two nodes is the number of edges that must be traversed to reach one node from another. The sum of the ultrametric distances between all nodes can be used as a score for code complexity. Further, the sum of the degrees of each node (the number of edges connected to the node) can be used as a score for code complexity. Further, the cyclomatic complexity of the code can be determined as the number of edges minus the number of nodes plus one. Constructing a matrix of ultrametric distances, the eigenvector of this matrix can be computed and used to determine the ‘direction or ‘influence’ of a module, indicating how changes in one module might impact others.

In some examples, the code analysis module 201 identifies 204 the respective complexity scores of the input source code 203 and the output source code 205 using one or more complexity metrics by calculating a first complexity score for the input source code 203 using a first complexity metric and calculating a second complexity score for the output source code using the first complexity metric. For example, the code analysis module 201 calculates 206 the first complexity score by applying one of the complexity analysis techniques discussed above to the input source code 203 and calculates the second complexity score by applying the same complexity analysis technique to the output source code 205. In some implementations, calculating a complexity score is carried out by calculating a total complexity score or average complexity score based on the individual complexity scores of each block of code (e.g., function, method, class, subroutine, etc.) in the source code.

It will be appreciated that this technique can be duplicated using multiple complexity metrics such that multiple complexity scores are calculated for the input source code and multiple complexity scores are generated for the output source code. For example, the code analysis module can calculate a third complexity score for the input source code and a fourth complexity score for the output source code using a second complexity metric. As such, the respective complexity scores of each of the input source code and the output source code can include one or more complexity scores based on one or more of a cyclomatic complexity metric, one or more Halstead metrics, one or more raw metrics such as source lines of code, a knot metric, a live variable metric, an ultrametric topology metric and a naturalness metric.

In some examples, the first complexity score and the second complexity score represent an aggregation of different complexity scores. Thus, in some examples, the code analysis module 201 identifies 204 the respective complexity scores of the input source code 203 and the output source code 205 using one or more complexity metrics by calculating 206 a first complexity score for the input source code using a plurality of complexity metrics, wherein the first complexity score represents a combination of the plurality of complexity metrics, and calculating 208 a second complexity score for the output source code using the plurality of complexity metrics. For example, a complexity score may be a complexity index computed from a weighted average calculated using multiple complexity metrics. In a particular implementation, an eigen vector is constructed from a plurality of complexity metrics. A base value is computed from the square root of the sum of the squares of each of these values. Respective base values computed for the input source code and the output source code can be used as the respective complexity scores for comparison between the input source code and the AI-generated output source code.

Different programming languages (e.g., COBOL and Java) use different vocabularies of operators and different syntaxes that, if not accounted for, could skew the complexity scores. Thus, in some examples, different complexity metric definitions are used for the input source code and the output source code. For example, in assessing cyclomatic complexity based on the number of decision points, the condition statements, branch statements, or operators that increment the count of decision points in one programming language should be made to correspond to the statements in the other programming language that have the same effect. Similarly, statistical analysis may reveal that source lines of code in one programming language is expected to be a particular percent larger than source lines of code in the other programming language. As such, complexity calculations can be adjusted based on the differences between the syntaxes of the programming language.

It will be appreciated that any single complexity metric or combination of complexity metrics described above may be used by the code analysis module 201 to identify the respective complexity scores for the input source code and the output source code. Further it will be appreciated that the code analysis module can use other complexity metrics and mathematical constructs not discussed above in a manner consistent with the present disclosure to quantify the complexity of the input source code and the output source code.

The method of FIG. 2 also includes generating 210, based on an evaluation of the respective complexity scores, a validation score 209 for the output source code 205. In some examples, the code analysis module 201 generates 210 a validation score 209 by comparing one or more complexity scores of the input source code to one or more complexity scores of the output source code and determining a validation score 209 that represents their similarity or dissimilarity. For example, the validation score 209 may be an absolute or relative deviation of the complexity score of the output source code from the complexity score of the input source code. In some examples, the validation score 209 may be based on an evaluation of multiple complexity scores using multiple complexity metrics for the input source code and the output source code, such as an average or weighted average of the various scores. In some examples, the code analysis module 201 may set a tolerance such as a threshold or range to determine whether the output source code has passed or failed validation. For example, the code analysis module may determine that the output source code has failed validation if the difference between the complexity scores is above a particular threshold or if the complexity score of the output source code is greater than the complexity score of the input source code. As such, in some implementations the validation score 209 may be a binary result such as pass/fail.

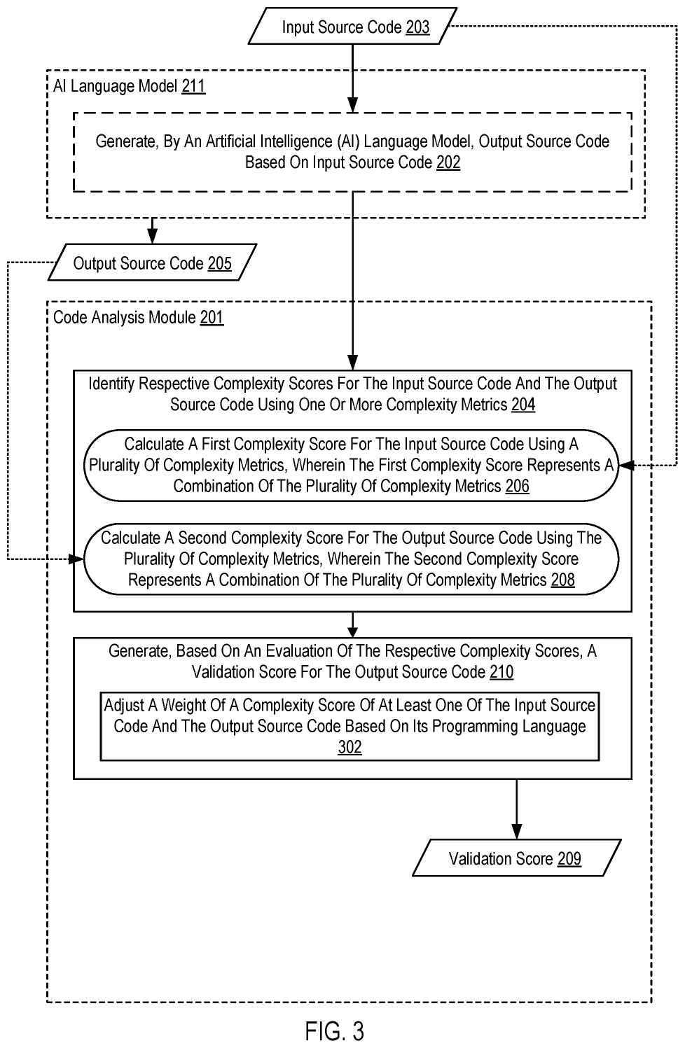

For further explanation, FIG. 3 sets forth a flowchart of an example method of using complexity metrics to assess code generated using artificial intelligence in accordance with some embodiments of the present disclosure. The method of FIG. 3 extends the method of FIG. 2 in that the method of FIG. 3 in that generating 210, based on an evaluation of the respective complexity scores, a validation score for the output source code 205 further includes adjusting 302 a weight of a complexity score of at least one of the input source code 203 and the output source code 205 based on its programming language. Some programming languages are, by their nature, more complex than other programming languages. For example, it is to be expected that a program written in assembly language will be typically more complex than the same program written in Java. To adjust for this disparity, in some examples the code analysis module 201 weights at least one of the input source code and the output source code based on the expected complexity of the programming language in which that source code is written. For example, where the input source code is part of a legacy codebase and the output source code is written in a more modern programming language, the code analysis module 201 may down weight the complexity score of the input source code to account for the expected decrease in complexity when translated to the modern programming language.

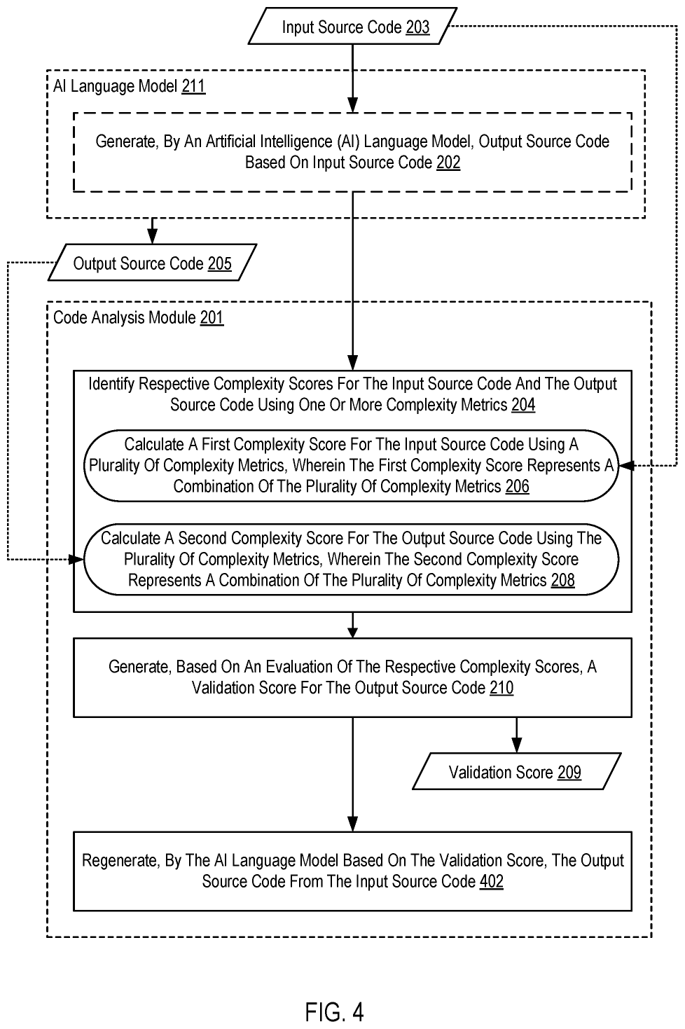

For further explanation, FIG. 4 sets forth a flowchart of an example method of using complexity metrics to assess code generated using artificial intelligence in accordance with some embodiments of the present disclosure. The method of FIG. 4 extends the method of FIG. 2 in that the method of FIG. 4 further includes regenerating 402, by the AI language model 211 based on the validation score 209, the output source code 205 from the input source code 203. In some examples, the code analysis module 201 determines that the validation score 209 for the output code is outside of an acceptable tolerance or otherwise indicates that the output source code has failed validation. Accordingly, the code analysis module 201 determines that the output source code should be regenerated. In some examples, the code analysis module 201 generates a second prompt much in the same manner as generating the first prompt; however, in this instance the prompt indicates to the AI language model that the AI language model should generate a different implementation. In such a case, the code analysis module 201 may generate a prompt such as “Regenerate code for block A” or “Regenerate code for block A that is syntactically different from the previously generated code.” In response, the AI language model regenerates alternative code for the input code corresponding to block A. In some implementations, the code analysis module 201 iteratively re-prompts the AI language model to regenerate the source code until the output source code passes validation or until a threshold number of attempts has been reached.

In some implementations, the code analysis module 201 adjusts one or more parameters of the AI language model in response to determining that the translation score is outside of the accepted tolerance. The AI language model can include configurable parameters that influence the creativity of the model's response to a prompt. For example, a temperature parameter adjusts the distribution of probabilities that can be used to select the next token for an output stream. In selecting the next token for an output stream, a lower temperature causes the language model to select tokens whose probabilities are within a narrower range, tending to more deterministic output, while a higher temperature causes the language model to select tokens whose probabilities are within a wider range, tending to more random output. Another example parameter is a top k parameter that controls the randomness of selecting the next token by telling the language model that it must select from the top k highest probability tokens. Yet another example parameter is a top p parameter that controls the randomness of selecting the next token by telling the language model that it must select from the highest probability tokens whose probabilities sum to or exceed the p value.

In some examples, the code analysis module 201 adjusts one or more parameters of the AI language model in response to determining that one or more iterations of generating the output source code failed a tolerance threshold. For example, as the number of iterations increases, the parameters that control the creativity of the AI language model may be adjusted to increase the randomness of the output. In this way, the AI language model can be induced to generate a solution that is dissimilar to the failed solutions presented in previous iterations. In some examples, adjusting one or more parameters is carried out by including a statement in a prompt to adjust the parameter, such as “Set temperature to 0.8.” It will be appreciated that the parameters of the language model can be adjusted at any stage of the processing. For example, in some implementations, a preprocessing stage analyzes the original source code before the AI language model generates new source code from the original source code and sets the language model parameters based on the analysis. For example, a statistical analysis of the original code may be employed to predict how creative or deterministic the language model should be in its output.

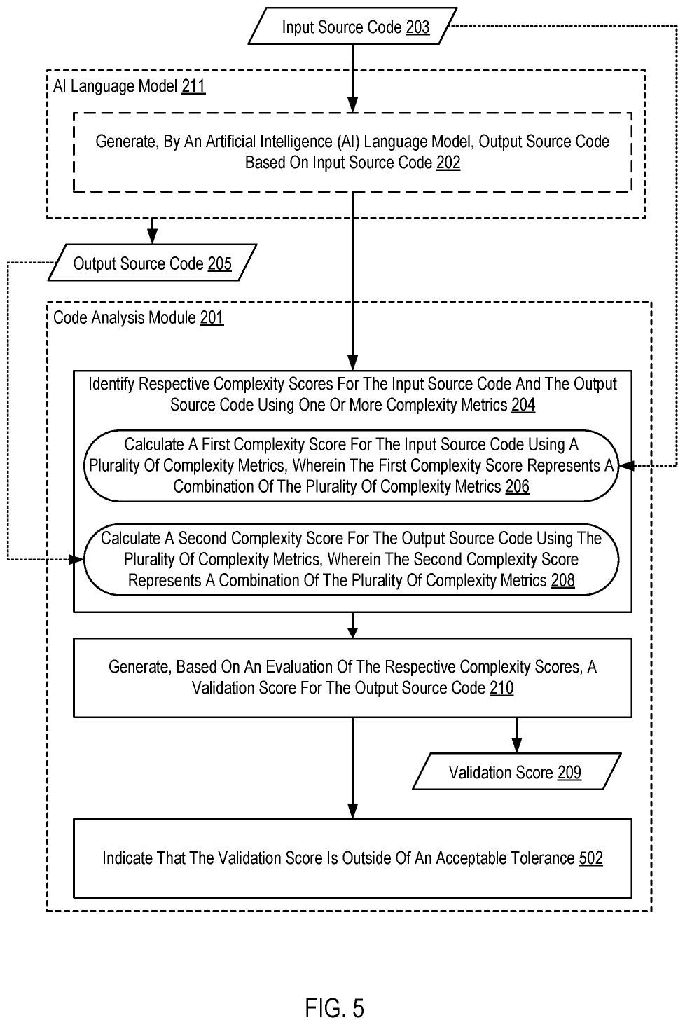

For further explanation, FIG. 5 sets forth a flowchart of an example method of using complexity metrics to assess code generated using artificial intelligence in accordance with some embodiments of the present disclosure. The method of FIG. 5 extends the method of FIG. 2 in that the method of FIG. 5 further includes indicating 502, in dependence upon the validation score, that the output source code failed validation. In some examples, the code analysis module 201 indicates 502 that the output source code failed validation in response to determining that the validation score is outside of an acceptable tolerance or that the validation score indicates validation failure. Indicating 502 that the output source code failed validation can include flagging the output source code or raising an alert to personnel indicating that the output source code failed validation.

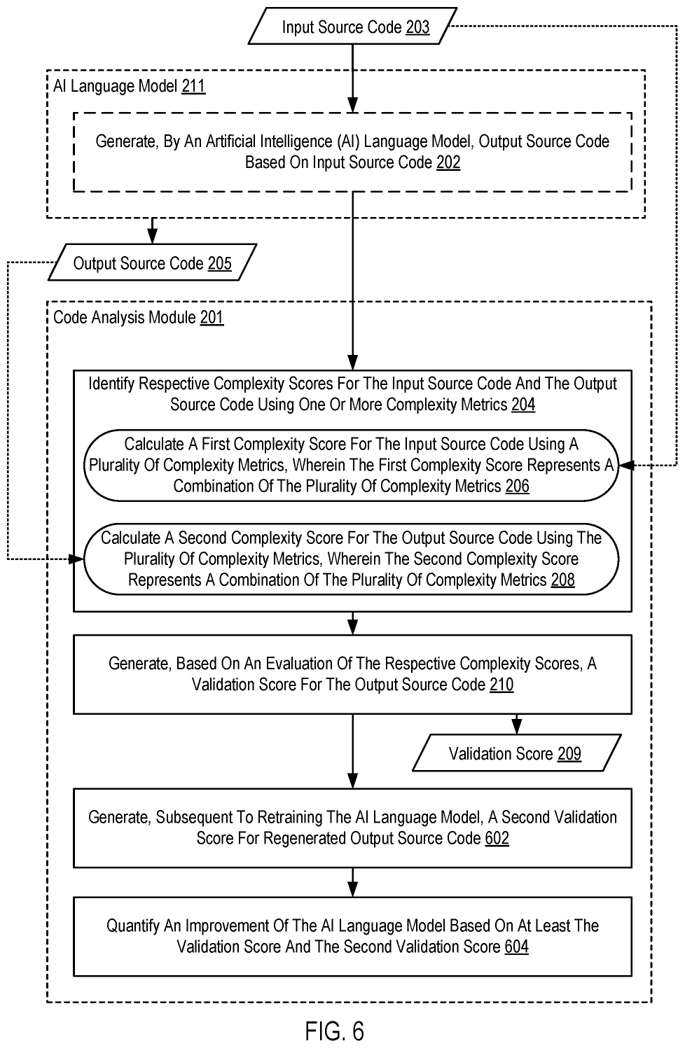

For further explanation, FIG. 6 sets forth a flowchart of an example method of using complexity metrics to assess code generated using artificial intelligence in accordance with some embodiments of the present disclosure. The method of FIG. 6 extends the method of FIG. 2 in that the method of FIG. 6 further includes generating 602, subsequent to retraining the AI language model 211, a second validation score for regenerated output source code. In some examples, the AI language model 211 is retrained on additional training datasets to improve the quality of the AI code translations of input source code. To assess whether the AI language model has improved in the quality and an accuracy of the code translations, and to quantify the improvement, the AI model is prompted to regenerate output source code based on the input source code with which the validation score was previously determined. In these examples, the code analysis module 201 generates 602 the second validation score in the manner described above using the same complexity metrics that were used to generate the initial validation score.

The method of FIG. 6 also includes quantifying 604 an improvement of the AI language model 211 based on at least the validation score and the second validation score. In some examples, the code analysis module 201 quantifies 604 the improvement of the AI language model 211 by comparing the initial validation score to the second validation score to determine whether the AI language model 211 is generating output source code that is more similar in complexity to the input source code.

While embodiments are useful in migrating or porting an application from one programming language to a different programming language, and from legacy programming language to a more modernized programming language, it will be appreciated that in some examples the original source code and the new source code may be written in the same programming language.

In view of the foregoing, using complexity metrics to assess code generated using artificial intelligence in accordance with the present disclosure provides a number of advantages. Embodiments of the present disclosure improve the accuracy and quality of automated code generation, and further improve the reliability and maintainability of the source code generated through automated code generation. The evaluation of complexity scores is advantageous in quantifying the validation of the output source code against the input source code and further indicates whether the translated code not only replicates the logical flow of the original but also maintains a similar level of structural intricacy. The evaluation of complexity scores is advantageous in determining whether AI-generated code needs to be regenerated, thus alleviating human effort to validate the AI-generated code. Further, the evaluation of complexity scores is useful in quantifying improvements in the accuracy and ability of the AI language model to translate source code.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method of using complexity metrics to assess code generated using artificial intelligence comprising:
generating, by an artificial intelligence (AI) language model, output source code based on input source code;
identifying respective complexity scores for the input source code and the output source code using one or more complexity metrics; and
generating, based on an evaluation of the respective complexity scores, a validation score for the output source code.

2. The method of claim 1, wherein the input source code is implemented in a first programming language and the output source code is implemented in a second programming language that is different from the first programming language.

3. The method of claim 1, wherein the one or more complexity metrics include one or more of a cyclomatic complexity metric, one or more Halstead metrics, a live variable metric, a knot metric, an ultrametric topology metric, and a complexity index based on a plurality of complexity metrics.

4. The method of claim 1, wherein identifying respective scores for the input source code and the output source code using one or more complexity metrics includes:
calculating a first complexity score for the input source code using a plurality of complexity metrics, wherein the first complexity score represents a combination of the plurality of complexity metrics; and
calculating a second complexity score for the output source code using the plurality of complexity metrics, wherein the second complexity score represents a combination of the plurality of complexity metrics.

5. The method of claim 1, wherein generating, based on an evaluation of the respective complexity scores, a validation score for the output source code includes:
adjusting a weight of a complexity score of at least one of the input source code and the output source code based on its programming language.

6. The method of claim 1 further comprising:
regenerating, by the AI language model based on the validation score, the output source code from the input source code.

7. The method of claim 1 further comprising:
indicating that the validation score is outside of an acceptable tolerance.

8. The method of claim 1 further comprising:
generating, subsequent to retraining the AI language model, a second validation score for regenerated output source code; and
quantifying an improvement of the AI language model based on at least the validation score and the second validation score.

9. An apparatus comprising:
a memory; and
a processing device, operatively coupled to the memory, the processing device configured to:
generate, by an artificial intelligence (AI) language model, output source code based on input source code;
identify respective complexity scores for the input source code and the output source code using one or more complexity metrics; and
generate, based on an evaluation of the respective complexity scores, a validation score for the output source code.

10. The apparatus of claim 9, wherein the input source code is implemented in a first programming language and the output source code is implemented in a second programming language that is different from the first programming language.

11. The apparatus of claim 9, wherein the one or more complexity metrics include one or more of a cyclomatic complexity metric, one or more Halstead metrics, a live variable metric, a knot metric, an ultrametric topology metric, and a complexity index based on a plurality of complexity metrics.

12. The apparatus of claim 9, wherein to identify respective scores for the input source code and the output source code using one or more complexity metrics the processing device is further configured to:
calculate a first complexity score for the input source code using a plurality of complexity metrics, wherein the first complexity score represents a combination of the plurality of complexity metrics; and
calculate a second complexity score for the output source code using the plurality of complexity metrics, wherein the second complexity score represents a combination of the plurality of complexity metrics.

13. The apparatus of claim 9, wherein to generate, based on an evaluation of the respective complexity scores, a validation score for the output source code the processing device is further configured to:
adjust a weight of a complexity score of at least one of the input source code and the output source code based on its programming language.

14. The apparatus of claim 9, where the processing device is further configured to:
regenerate, by the AI language model based on the validation score, the output source code from the input source code.

15. The apparatus of claim 9, where the processing device is further configured to:
generate, subsequent to retraining the AI language model, a second validation score for regenerated output source code; and
quantify an improvement of the AI language model based on at least the validation score and the second validation score.

16. A non-transitory computer readable storage medium storing instructions which, when executed, cause a processing device to:
identify respective complexity scores for input source code and output source code using one or more complexity metrics, wherein the output source code is generated by an artificial intelligence (AI) language model based on the input source code; and
generate, based on an evaluation of the respective complexity scores, a validation score for the output source code.

17. The computer readable storage medium of claim 16, wherein the output source code is generated by the AI language model in response to prompting the AI language model to generate the output source code using the input source code as part of a prompt.

18. The computer readable storage medium of claim 16, wherein the input source code is implemented in a first programming language and the output source code is implemented in a second programming language that is different from the first programming language.

19. The computer readable storage medium of claim 16, wherein the instructions further cause the processing device to:
prompt the AI language model, based on the validation score, to regenerate the output source code from the input source code.

20. The computer readable storage medium of claim 16, wherein the instructions further cause the processing device to:
generate, subsequent to retraining the AI language model, a second validation score for regenerated output source code; and
quantify an improvement of the AI language model based on at least the validation score and the second validation score.
